(19) United States
(12) Patent Application Publication
(10) Pub. No.: US 2007/0250495 A1
(43) Pub. Date: Oct. 25, 2007

(54) Method and System For Accessing Referenced Information

(76) Inventors: Eran Belinsky, Haifa (IL); Eyal Sonsino, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/380,029

(22) Filed: Apr. 25, 2006

(51) Int. Cl. G06F 17/30

(52) U.S. Cl. 707/5

(57) ABSTRACT

A method and system are provided for accessing referenced information from non-hyperlink references (232) in a text document (214). Key data (260) identifying the referenced information is extracted from a reference (232) in the text document (214). A search (206) is requested for the referenced information using the key data (260), and an address for the referenced information is retrieved. Optionally, the reference (232) in the document (214) is converted into a hyperlink (250) to the address for the retrieved referenced information.

### FIELD OF THE INVENTION

This invention relates to the field of references in text documents. In particular, the invention relates to accessing referenced information from references in a text document.

### BACKGROUND OF THE INVENTION

Many text documents contain references to other documents or information. When reading a document which includes a reference to other information, a reader may be interested in reading the referenced information, skimming through the information, or even just reading an abstract, summary or heading of the information.

One category of text documents containing references is scientific articles which rely heavily on reference methodology. Articles reference articles on the subject matter, citing previous work done in the research area. Most authors of articles use a standard reference syntax, citing the article's title, authors, publication date, and location, etc. In order to obtain the referenced article, the reader has to consult search engines to retrieve the referenced article. Such search engines may be general purpose search engines (for example, Google: http://www.google.com or Yahoo!: http://www.yahoo.com), or specific search engines that specialize in scientific articles (for example, Google Scholar: http://scholar.google.com/, citeseer: http://citeseer.ist.psu.edu/ or DBLP: http://www.informatik.uni-trier.de/˜ley/db/index.html). (GOOGLE and GOOGLE SCHOLAR are trade marks of Google, Inc., YAHOO! is a trade mark of Yahoo! Inc., CITESEER is a trade mark of NEC Research Institute, Inc.) Consulting a search engine to retrieve a referenced article is a manual process that suffers from the drawbacks of every manual process: it takes time and effort, and is prone to human error.

Patent documents are another category of text document which routinely include references to other information or documents. Such information or documents are referred to when describing the known prior art and are often provided in the form of a patent application or publication number, or the standard reference syntax for scientific articles.

Legal and court reports contain references to precedents of previous cases, rules, and legislation all of which require time and a knowledge of the correct resource locations to obtain.

In addition to the above specific examples, many other examples of text documents including references to information may be envisaged.

Hyperlinks are the standard way to represent a reference from one computer-readable text document to another. A hyperlink is a reference in a hypertext document to another document or other resource. Combined with a data network and suitable access protocol, a computer can be instructed to retrieve the referenced resource by selecting the hyperlink.

Article references, patent or legal references are all likely candidates for hyperlinking; however, many authors of documents in these fields and many other fields do not add references as hyperlinks but settle for conventional reference syntax of the particular field.

Additionally, there are a large number of older documents in many different fields which have been converted into computer-readable text and are available via the Internet and include references to other information or resources which have not been converted into hyperlinks.

### SUMMARY OF THE INVENTION

According to a first aspect of the present invention there is provided a method for accessing referenced information, comprising: providing a text document; extracting key data from a reference in the text document, wherein the key data identifies the referenced information; requesting a search for the referenced information using the key data; and retrieving an address for the referenced information.

The method may include converting the reference in the document into a hyperlink to the referenced information. The method of converting is implementation-specific.

The step of retrieving an address for the referenced information retrieves a data repository path such as a Uniform Resource Locator (URL) and the hyperlink provides the URL as the hyperlink target. Retrieving an address for the referenced information may retrieve an address for a summary of the referenced information, such as an abstract.

The method may include identifying a reference in the text document to referenced information. For example, given a field of the text document, rules may he applied to identify a standard form of a reference.

The step of requesting a search may include entering the key data into one or more search engines. The step of extracting the key data includes applying rules to the reference to convert it into key data for searching.

According to a second aspect of the present invention there is provided a system for accessing referenced information, comprising: a reference extractor for extracting key data from a reference in the text document, wherein the key data identifies the referenced information; a search manager for searching for the referenced information using the key data; and retrieval mechanism for retrieving an address for the referenced information.

According to a third aspect of the present invention there is provided a computer program product stored on a computer readable storage medium, comprising computer readable program code means for performing the steps of: extracting key data from a reference in the text document, wherein the key data identifies the referenced information: requesting a search for the referenced information using the key data; and retrieving an address for the referenced information.

According to a fourth aspect of the present invention there is provided a method of providing a service to a customer over a network to access referenced information, the service comprising: receiving a text document; extracting key data from a reference in the text document, wherein the key data identifies the referenced information; requesting a search for the referenced information using the key data; and retrieving an address for the referenced information.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a known computer system in which the present invention may be implemented;

FIGS. 2A, 2B & 2C are block diagrams of a computer system in accordance with the present invention showing progressively more schematic representations of the system operation; and

FIG. 3 is a flow diagram of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repealed among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

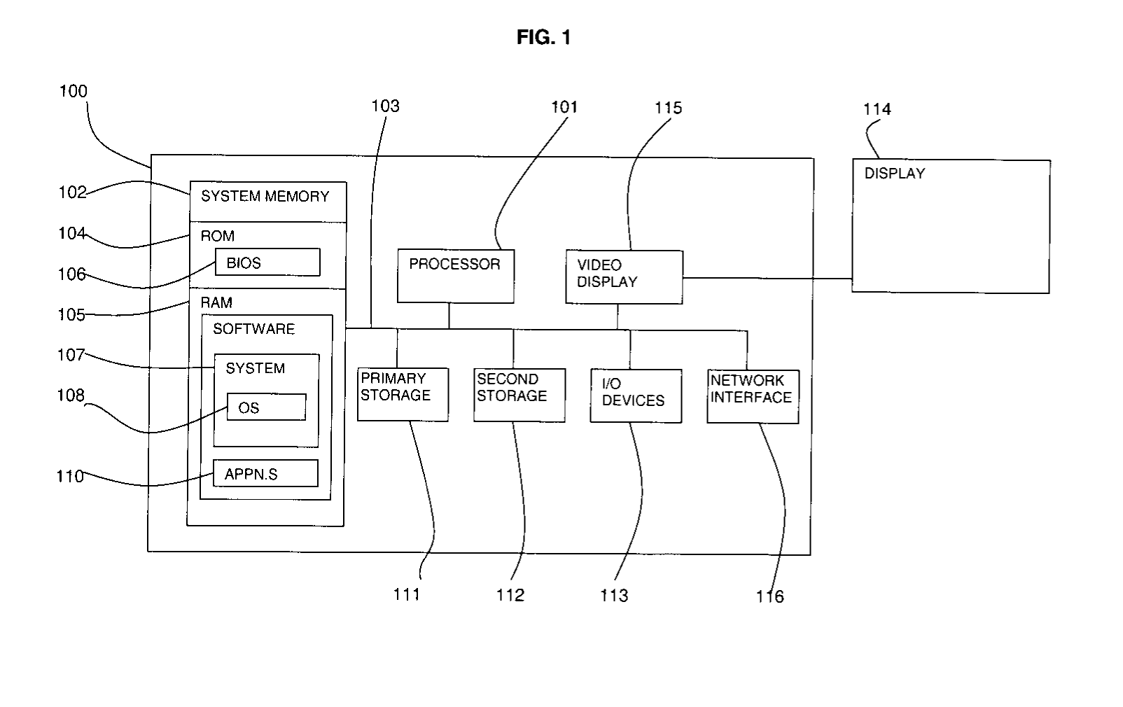

Referring to FIG. 1, an exemplary system for implementing the invention includes a data processing system 100 suitable for storing and/or executing program code including at least one processor 101 coupled directly or indirectly to memory elements through a bus system 103. The memory elements can include local memory employed during actual execution of the program code, bulk storage, and cache memories which provide temporary storage of at least some program code in order to reduce the number of times code must be retrieved from bulk storage during execution.

The memory elements may include system memory 102 in the form of read only memory (ROM) 104 and random access memory (RAM) 105. A basic input/output system (BIOS) 106 may be stored in ROM 104. System software 107 may be stored in RAM 105 including operating system software 108. Software applications 110 may also be stored in RAM 105.

The system 100 may also include a primary storage means 111 such as a magnetic hard disk drive and secondary storage means 112 such as a magnetic disc drive and an optical disc drive. The drives and their associated computer-readable media provide non-volatile storage of computer-executable instructions, data structures, program modules and other data for the system 100. Software applications may be stored on the primary and secondary storage means 111, 112 as well as the system memory 102.

The data processing system 100 may operate in a networked environment using logical connections to one or more remote computers via a network adapter 116.

Input/output devices 113 can be coupled to the system either directly or through intervening I/O controllers. A user may enter commands and information into the system 100 through input devices such as a keyboard, pointing device, or other input devices (for example, microphone, joy stick, game pad, satellite dish, scanner, or the like). Output devices may include speakers, printers, etc. A display device 114 is also connected to system bus 103 via an interface, such as video adapter 115.

A text document may be accessed, viewed, or edited in many different forms of text viewer or word processing applications on a computer system such as that illustrated by FIG. 1. The text document may be stored locally on the computer system, stored remotely on another system accessed via a network, or stored on removable media (such as floppy disks, CD-ROMs, etc.).

The described method and system provides a mechanism for use with text viewer and word processor applications that accesses referenced information from non-hyperlink references in a text document. The mechanism extracts the necessary information for an automated background search performed to find the referenced information. The URL (Uniform Resource Locator) retrieved from the search process can be used to convert the reference in the text document to a hyperlink to the referenced information.

A hyperlink (or hypertext link) is a reference in a hypertext document to another document or other resource. A link has two ends, a source anchor and a destination anchor. The source anchor is the item in a document from which the link may be activated. The destination anchor (or link target) is an address of the information to be linked and is most commonly a Uniform Resource Locator (URL) and can refer to a webpage or other resource. The destination anchor can refer to a position in a URL by means of a HyperText Markup Language (HTML) element with an attribute at the position of the HTML document.

Hyperlinks are provided in HTML or Extensible Markup Language (XML) documents as well as in PDF documents, word processing documents, spreadsheets, etc. An application viewing or editing the document (for example, a web browser, a text viewer, a word processing application, etc.) may display the source anchor of a hyperlink in some distinguishing way. For example, in the case of a text document, as one or more words in a different colour, font, style. In a graphical user interface, a mouse cursor may change appearance when pointed to a hyperlink.

When a hyperlink is selected in a hypertext documents a browser application uses the destination anchor to retrieve the linked document or resource and to display it to the user. This may he done by opening a new display window in addition to the hypertext document with the hyperlink.

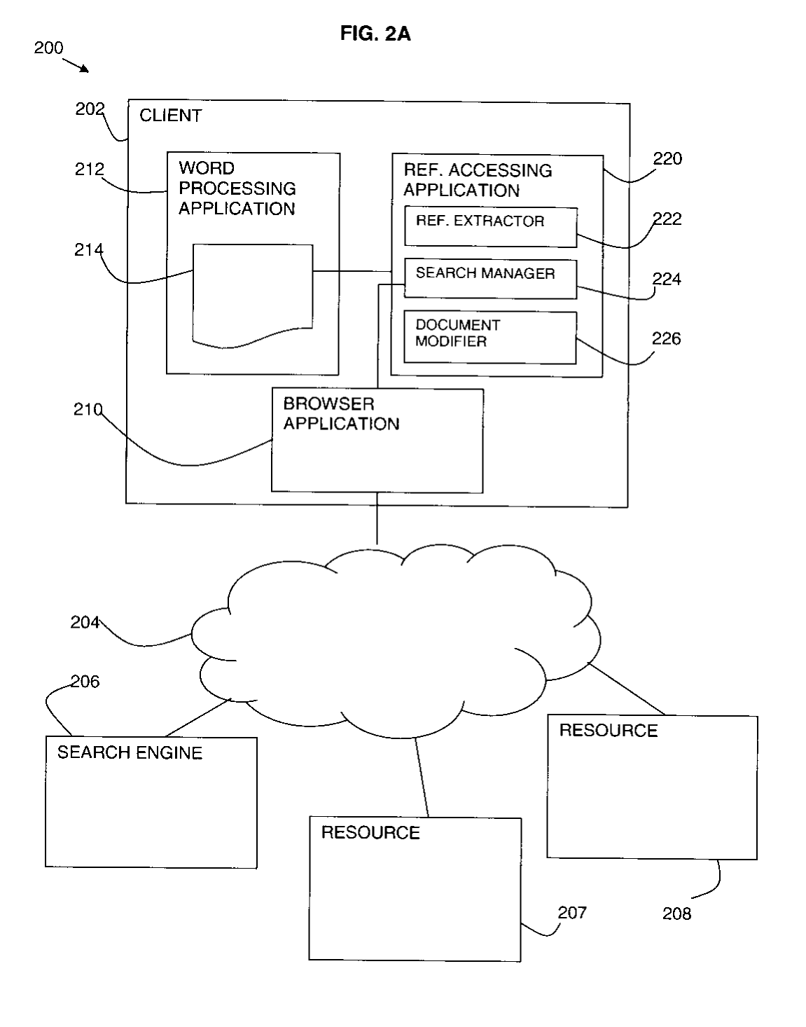

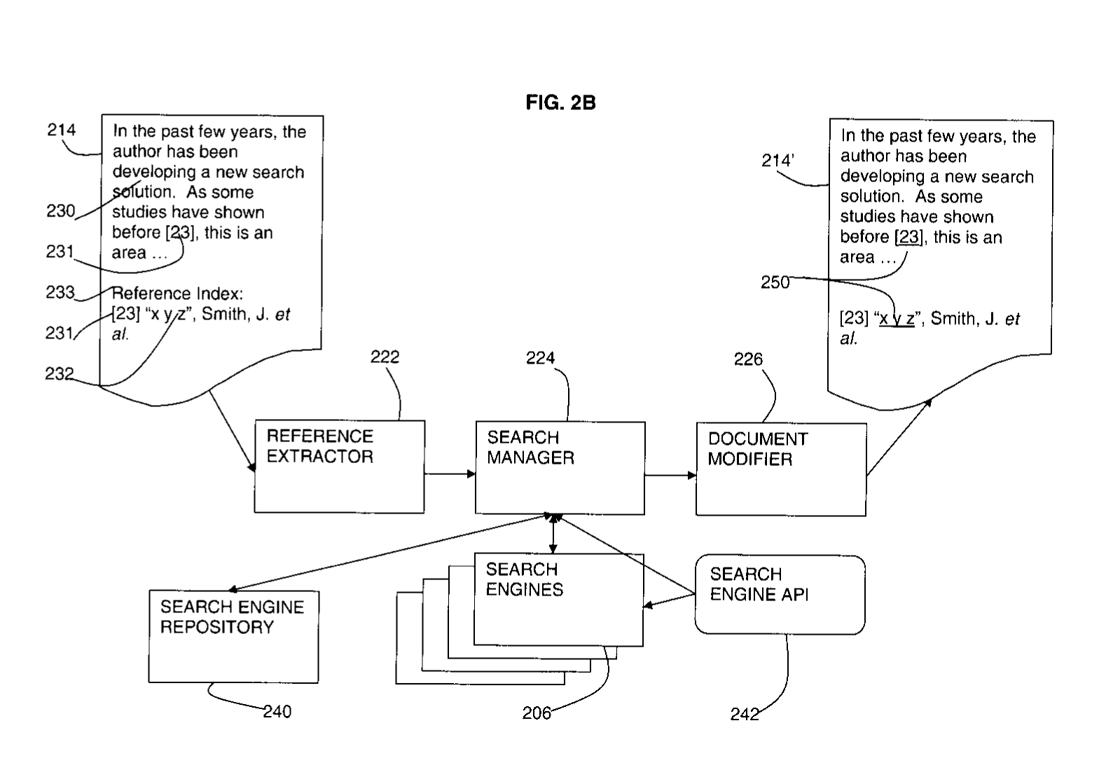

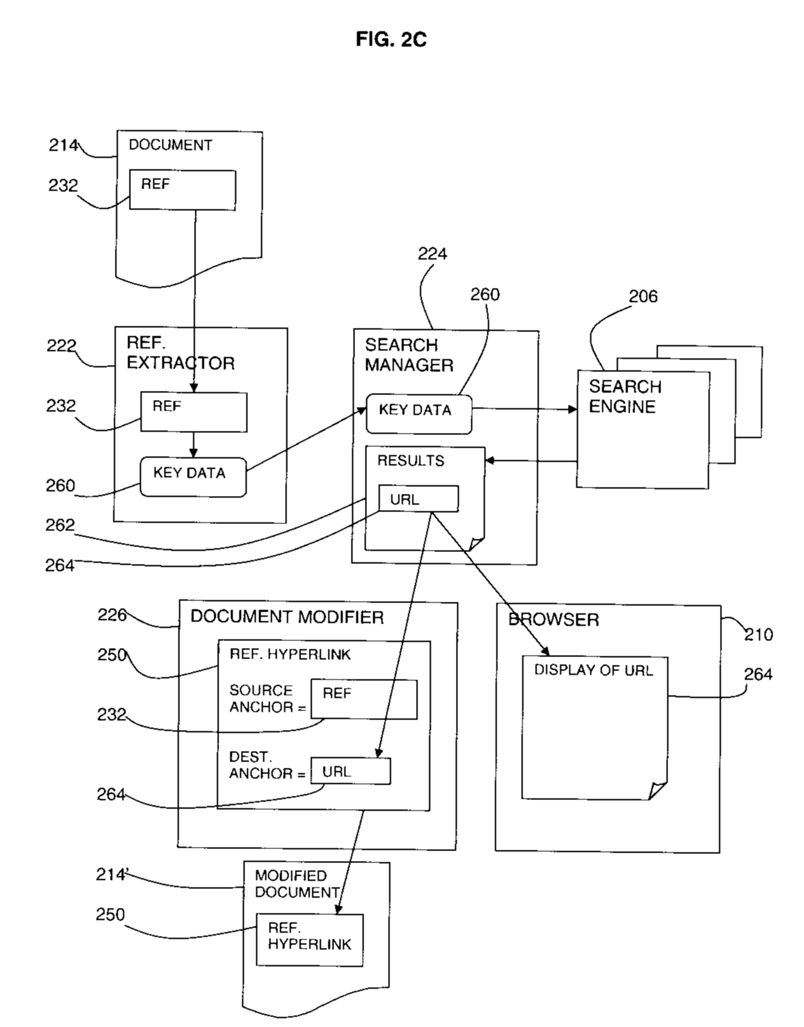

Referring to FIG. 2A. a system 200 is shown in which a client computer system 202 is connected via a network 204 to a search engine 206 and multiple resources 207, 208. The network may be the Internet, an Intranet, or other public or private networks. The client system 202 has a browser application 210 which enables a user of the client system 202 to retrieve resources 207, 208 via the network using the URLs of the resources 207, 208. A search engine 206 may be accessed by the browser application 210 to located a resource 207, 208 of interest to the user, but for which the user does not know the URL.

The client system 202 includes a text viewer or word processing application 212 which can display a text document 214 on a display of the client system 202. The described system includes a reference accessing application 220. The reference accessing application 220 provides a mechanism for accessing referenced information from non-hyperlink references in a text document 214. The references in the text document 214 may be text in the form of words or numbers.

The reference accessing application 220 may include a reference extractor 222, a search manager 224 and a document modifier 226, although one or more of these components may be provided separately or omitted.

The reference accessing application 220 may be integrated with a text viewer or word processing application 212 or may be a separate application which may be invoked when a text document 214 is identified as including non-hyperlink references. The reference accessing application 220 aims to let text viewers and word processor applications 212 access the resource information in cases where a hyperlink was not provided.

FIG. 2B shows the components of FIG. 2A in an operational representation. A text document 214 includes text 230 which may include a reference to other information. In this example embodiment, the text document 214 is shown as a scientific article with a reference 231 to another article 232. The reference 231 in this example is given as a number in the text 230 and a reference index 233 provided at the end of the document 214 lists the reference numbers 231 and the details of the referenced article 232. In an alternative example embodiment, the reference may be text within the body of the document 214.

The reference extractor 222 identifies the reference 231 in the text document 214 and extracts the key data identifying the referenced article 232. The extracted data may be text identifying the referenced information (for example, a title of a referenced article), or may be a number (for example, in the case of a reference to a published patent or patent application), or a combination of words and numbers (for example, in the case of a reference to a legal statue) or other forms of data.

The reference extractor 222 may be general or custom-tailored for a specific reference domain. If the reference extractor 222 is customised to the domain of scientific articles, it can be configured to highlight reference numbers in the text but to use the reference data provided in a reference index usually provided at the end of the article.

Sometimes not all the reference information is given. An implementation embodiment is provided with rules to enable the reference extractor 222 to deduce from the reference data additional information. For example, in articles where the list of authors is long, only the name of the first author is given, followed by the Latin phrase “et al”. A rule recognises the term “et al” and knows that the article has more than one author and that the first author's name was provided. Similarly, abbreviations of terms can be recognised. For example, in the case of patent application numbers, country codes can be extracted and the number correctly formatted for a patent search database.

The search manager 224 coordinates the use of one or more search engines 206 to locate the referenced article 232 as a resource 207, 208 on the network. The extracted data is fed to the set of one or more search engines 206. A set of predefined search engines may be used by the search manager 224 for locating the referenced information, as configured by the user. The user may add additional search engines (for example, an Intranet search engine) in order to increase the search capabilities. The search manager 224 may use a search engine repository 240 of indexed resources.

In an additional implementation, a specific request/response application programmable interface 242 is provided by search engines 206 using web services for performing this specific task. The API 242 allows requests for the service to be made by the reference accessing application 220. Such an API will be based on a request/response mechanism. A request will consist of a set of parameters including a de-composition of the reference text and may include additional information. A response will include a set of relevant URLs in which the requested reference was found. An empty result set indicates that no relevant documents were found.

The various search engines 206 attempt to locate the referenced information on the world wide web and retrieve its URL, or, a URL of only part of the information if all the information is not available on-line. For example, only an abstract of a referenced article may be available.

After a URL is retrieved, the document modifier 226 will change the reference 231 in the document 214′ from plain text into a clickable hyperlink, the target of which is the retrieved URL. So, when the user clicks on the hyperlink, he will navigate to the referenced information.

When a URL is retrieved, the document, or a relevant part of it, is re-rendered in the text viewer or word processor. The referenced text will be rendered in the manner that is used to present hyperlinks in the application. The hyperlink target will be set to be the retrieved URL.

A document may contain repeated references to the same information. The reference extractor 222 recognises the repeat reference and the document modifier 226 replaces all references with the hyperlink. As illustrated in FIG. 2B, where there is a reference index 233, the reference number 231 and the reference name 232 may both be replace with hyperlinks 250.

The document modifier 226 may convert a text document to add hyperlinks to any non-hyperlinked references. If the document 214 is stored locally on the client system 200, the stored document 214 may be automatically updated to the modified document 214′. If the document 214 is a remotely stored document being viewed by the client system 200 (such as a web page) the modified version 214 may be stored locally on the client system 200.

The document modifier 226 may be omitted if the document 14 is a remotely stored document such as a web page and the user does not wish to store a local copy. In this case, the reference will be retrieved and displayed without modifying the document 214 to include the hyperlink.

During editing of a text document 14, the reference accessing application 220 may automatically link the references to hyperlinks 250. The reference accessing application 220 may carry out an automated background search during editing of the text document 214.

FIG. 2C provides a more schematic representation of the process carried out by the system. A document 214 is provided with a reference 232 in the form of plain text or numbers. The reference extractor 222 extracts the reference 232 from the document 214 and determines the key data 260 which is used to search for the referenced information. The search manager 224 feeds the key data 260 to search engines 206 which return results 262 including one or more URLs 264 for the referenced information. If there is more than one relevant URL 264, the URL for the information with the closest match to the reference is selected.

A browser 210 displays the selected URL 264 on the client system enabling a user to read the referenced information in conjunction with the document 214.

A document modifier 226 creates a reference hyperlink 250 using the reference 260 as the source anchor and the selected URL 264 as the destination anchor. The reference hyperlink 250 is added to the modified document 214′ in place of the reference 232.

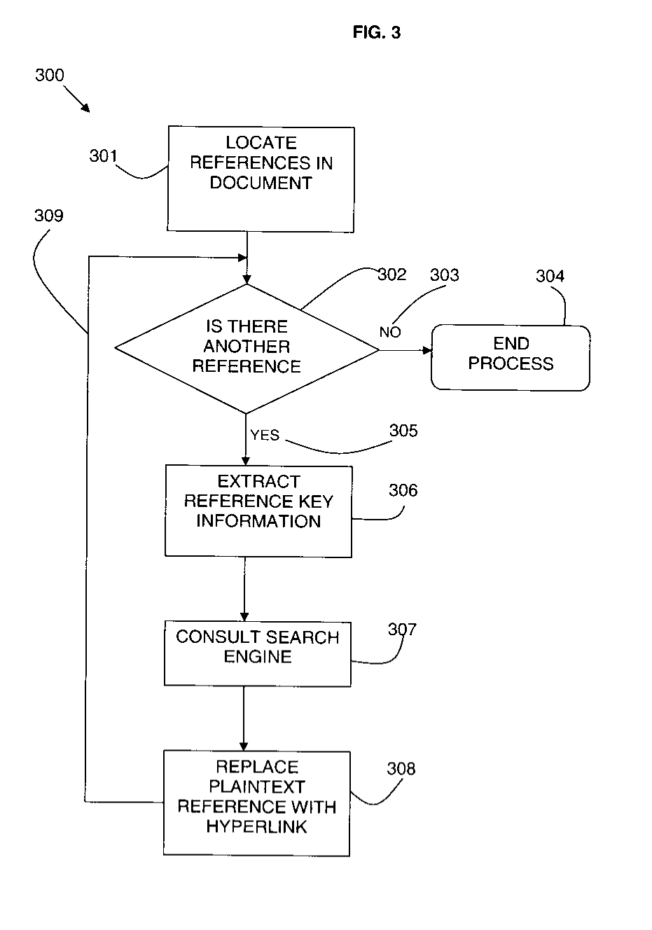

Referring to FIG. 3, a flow diagram 300 is provided showing the method of reference accessing. Firstly, references are located 301 in a document. This may be carried out manually by a user by highlighting in a graphical user interface the references in a text document. Alternatively, this may be an automated process and the automation may be configured to recognize reference formats according to the field of the text document.

It is determined 302 if there is a next reference. If there are no or no-more references 303, the process ends 304. If there is a next reference 305, the key data of the reference is extracted 306. A search engine is consulted 307 using the key data.

The plaintext in the document is replaced 308 with a hyperlink to the resource of the referenced information as located by the search engine. The process then loops 309 to determine 302 if there is a next reference.

The described method and system allow a document to be detached from specific reference locations that may change over time, as well as allowing organisations to provide different or specialised search repositories.

Referenced documents may be removed from one location and placed in another location and the referenced document will still be found by the search mechanism. This also allows organizations to switch repository providers. For example, legal documents may be provided by various providers, so the organisation may switch from one provider to another (for example, because they provide cheaper rates) and still find their referenced documents, simply by replacing the data repository path.

Another benefit is access control. For example, Alice uses a computer within her company's intranet and Bob has a computer within his company's intranet. Alice may get a referenced document from a repository within her organization's intranet, while Bob will get the referenced document from a repository within his organization's intranet. However, Carol, whose computer is connected to the internet will not get the referenced document.

A reference accessing service for text document references may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for accessing referenced information, comprising:
providing a text document;
extracting key data from a reference in the text document, wherein the key data identifies the referenced information;
requesting a search for the referenced information using the key data; and
retrieving an address for the referenced information.

2. A method as claimed in claim 1, including converting the reference in the document into a hyperlink to the referenced information.

3. A method as claimed in claim 2, wherein retrieving an address for the referenced information retrieves a Uniform Resource Locator (URL) and the hyperlink provides the URL as the hyperlink target.

4. A method as claimed in claim 1, including identifying a reference in the text document to referenced information.

5. A method as claimed in claim 1, wherein requesting a search includes entering the key data into one or more search engines.

6. A method as claimed in claim 1, wherein retrieving an address for the referenced information retrieves an address for a summary of the referenced information.

7. A method as claimed in claim 1, wherein extracting the key data includes applying rules to the reference to convert it into key data for searching.

8. A system for accessing referenced information, comprising:
a reference extractor for extracting key data from a reference in the text document, wherein the key data identifies the referenced information;
a search manager for searching for the referenced information using the key data; and
retrieval mechanism for retrieving an address for the referenced information.

9. A system as claimed in claim 8, including a converter for converting the reference in the document into a hyperlink to the referenced information.

10. A system as claimed in claim 9, wherein the retrieval mechanism retrieves the Uniform Resource Locator (URL) of the referenced information and the hyperlink provides the URL as the hyperlink target.

11. A system as claimed in claim 8, including an identifier for identifying a reference in the text document to referenced information.

12. A system as claimed in claim 8, wherein the search manager searches for the referenced information with the key data using one or more search engines.

13. A system as claimed in claim 8, wherein the text document is viewed or edited with a text viewer or word processing application and the system is implemented in the text viewer or word processing application.

14. A system as claimed in claim 13, wherein the system is automatically implemented during editing of a text document.

15. A system as claimed in claim 8, wherein one or more search engines provide a request and response API for performing the search as requested by the system.

16. A system as claimed in claim 8, wherein a set of search engines used by the search manager is configurable and additional search engines may be added.

17. A system as claimed in claim 8, wherein the reference extractor is customised to the field of references in the text document.

18. A system as claimed in claim 8, wherein the retrieval mechanism invokes a web browser to retrieve the referenced information.

19. A computer program product stored on a computer readable storage medium, comprising computer readable program code means for performing the steps of:
extracting key data from a reference in the text document, wherein the key data identifies the referenced information;
requesting a search for the referenced information using the key data; and
retrieving an address for the referenced information.

20. A method of providing a service to a customer over a network to access referenced information, the service comprising:
receiving a text document;
extracting key data from a reference in the text document, wherein the key data identifies the referenced information;
requesting a search for the referenced information using the key data; and
retrieving an address for the referenced information.
